(19) United States
(12) Patent Application Publication
(10) Pub. No.: US 2002/0024519 A1
(43) Pub. Date: Feb. 28, 2002

(54) System and method for producing three-dimensional moving picture authoring tool supporting synthesis of motion, facial expression, lip synchronizing and lip synchronized voice of three-dimensional character

(75) Inventor: Jong Man Park, Sungnam-City (KR)

Correspondence Address: Ladas & Parry, 26 West 61st Street, New York, NY, 10023, US

(73) Assignee: ADAMSOFT CORPORATION

(21) Appl. No.: 09/816,592

(22) Filed: Mar. 23, 2001

(30) Foreign Application Priority Data
Aug. 20, 2000 (KR) 2000-55309

(51) Int. Cl. G06T 15/70; G06T 13/00

(52) U.S. Cl. 345/474; 345/473

(57) ABSTRACT

Disclosed is a system for producing a moving picture, comprising: a memory system adapted to store information on a facial expression, the shape of lips, and a motion of a character; a speech information-converting engine adapted to receive text information and/or previously recorded speech information from a user and to convert the inputted text information and/or previously recorded speech information into a corresponding speech information; a lip synchronizing-creating engine adapted to extract phoneme information from speech information outputted from the speech information-converting engine, and to generate a facial expression and the shape of lips of the character corresponding to the extracted phoneme information from the memory system; an animation-creating engine adapted to receive motion information from the user and to generate a movement of the character corresponding to the motion information from the memory system; and a synthesis engine adapted to synthesize the facial expression and the lips shape of the character generated from the lip synchronizing-creating engine and the movement of the character generated from the animation-creating engine to display the synthesized ones on a screen.

### BACKGROUND OF THE INVENTION

1. Field of the Invention

The present invention relates to a system and method for producing a three-dimensional (3D) animation character in real time, and more particularly, a system and method for in real time producing a moving picture of a three-dimensional (3D) character by synthesizing a motion, a facial expression, and a lip synchronizing and a lip synchronized voice of the three-dimensional (3D) character.

2. Description of the Prior Art

In case of the production of a moving picture using a three-dimensional (3D) character, a graphic developer traditionally designs images with a frame unit, and integrates the images by manual operations to perform an animation or captures each motion according to an action one by one. Then, each motion is connected with each other as a series of action processes.

However, in this type of the production of a moving picture, it is not easy to use previously produced data in other operations. For this reason, an operation cannot be performed without an expert, and although there exists an expert, it is difficult to correct the content of an operation performed already except a person who had originally performed the operation. As a result, the period of time for producing a moving picture is prolonged, and many experts on production of the moving picture are required. Moreover, the cost of production of the moving picture is increased.

Further, since there was not a moving picture producing tool for, in real time, generating a lip synchronizing in response to an output of a voice, there was required an additional operation in which a professional radio performer dubs a voice on a previously produced scene while viewing the scene, or manual operations had to be performed by frame of an image on the scene to conform to a recorded voice.

Such a moving picture producing tool typically includes a 3D MAX or MAYA, etc., as three-dimensional (3D) graphic software. But, an animation definition scheme supported in this program is a scheme in which a start point and an end point are determined, and an intermediate value is calculated by a function. Finally, since an animator has to, in detail, establish an image by frame, only a professional graphic designer could perform such an operation. Also, the animation definition work is a complex one on which even a professional graphic designer spend a lot of time.

Particularly, in a conventional production of a moving picture, a lip synchronizing is not performed automatically so that an output of a voice and a motion of lips are coincident with each other. Accordingly, in case of a conventional general moving picture producing tool, every time an animation scenario is modified, a motion must be captured again and a voice must be recorded in a studio again. Also, a lip synchronizing operation must be performed newly according to a manuscript. As a result, a lot of time and cost are required for production of one moving picture.

### SUMMARY OF THE INVENTION

Therefore, the present invention has been made in view of the above-mentioned problems, and it is an object of the present invention to provide a system and method for producing a moving picture in which a motion of a character is processed automatically according to an outputted voice.

It is another object of the present invention to provide a system and method for producing a moving picture in which various motions and facial expressions of a character are stored in a data base, motions and facial expressions that a user wants are outputted easily from the data base, and which automatically processes a lip synchronizing for making outputted voice information coincident with the shape of lips of the character.

It is still another object of the present invention to provide a system and method for producing a moving picture in which an inputted text content is converted into a speech, and a motion of a character is processed by the converted speech.

It is yet another object of the present invention to provide a system and method for producing a moving picture in which phoneme information is extracted to automatically process a lip synchronizing, or phoneme information is extracted from previously recorded speech information to automatically process a lip synchronizing by using a speech information-converting engine for converting an inputted text content into a speech and processing a motion of a character according to the converted speech.

According to an aspect of the present invention, there is provided a system for producing a moving picture, comprising:

a memory system adapted to store information on a facial expression, the shape of lips, and a motion of a character;

a speech information-converting engine adapted to receive text information and/or previously recorded speech information from a user and to convert the inputted text information and/or previously recorded speech information into a corresponding speech information;

a lip synchronizing-creating engine adapted to extract phoneme information from speech information outputted from the speech information-converting engine, and to generate a facial expression and the shape of lips of the character corresponding to the extracted phoneme information from the memory system;

an animation-creating engine adapted to receive motion information from the user and to generate a movement of the character corresponding to the motion information from the memory system; and

a synthesis engine adapted to synthesize the facial expression and the lips shape of the character generated from the lip synchronizing-creating engine and the movement of the character generated from the animation-creating engine to display the synthesized ones on a screen.

Preferably, the facial expression of the character may include at least one of an opening of a mouth of the character, a rising of both tails of lips thereof, a lowering of both tails of lips thereof, a right and left stretching of lips thereof, a tightening of lips thereof like “o” pronunciation, a tightening of lips thereof like “u” pronunciation, an opening of only lips thereof without pulling a chin downward, a raising of both tails of eyes of thereof, a closing of eyes thereof, a raising of eyebrows thereof, and a knitting of eyebrows thereof.

Preferably, the moving picture producing system may further include: modeling means adapted to model a sketch character and texture mapping means adapted to map a texture to the modeled sketch character; a motion engine adapted to implement the movement of the character according to inputted motion information; a facial expression engine adapted to implement the facial expression of the character according to inputted facial expression information; a background scene engine adapted to implement a background scene according to inputted background scene information; and a sound engine adapted to synthesize a sound according to inputted sound information.

Preferably, the memory system may include: a motion library adapted to store motion information of the character; a facial expression library adapted to store facial expression information of the character; a background scene library adapted to store information on a background scene of the character; and a sound library adapted to store sound information.

According to another aspect of the present invention, there is also provided a system for producing a moving picture, comprising:

a memory system adapted to store information on a facial expression, the shape of lips, and a motion of a character;

a lip synchronizing-creating engine adapted to extract phoneme information from speech information inputted by a user, and to generate a facial expression and the shape of lips of the character corresponding to the extracted phoneme information from the memory system;

an animation-creating engine adapted to receive motion information from the user and to generate a movement of the character corresponding to the motion information from the memory system; and

a synthesis engine adapted to synthesize the facial expression and the lip shape of the character generated from the lip synchronizing-creating engine and the movement of the character generated from the animation-creating engine to display the synthesized ones on a screen.

According to another aspect of the present invention, there is also provided a method for producing a moving picture, comprising the steps of:

producing a basic face of a character;

producing various facial expressions of the character with respect to the basic face thereof;

calculating a difference value between the basic face of the character and each of the various facial expressions thereof;

generating a vector value from the calculated difference value and parameterizing the generated vector value; and

outputting a corresponding face shape of the character according to the parameterized vector value.

According to another aspect of the present invention, there is also provided a method for producing a moving picture, comprising the steps of:

producing a basic figure for a face and a body of a character;

producing various figures of the character which can be created by a variation of the shape of the face or the body of the character with respect to the basic figure thereof;

calculating a difference value between the basic figure of the character and each of the various figures thereof;

generating a vector value from the calculated difference value and parameterizing the generated vector value; and

outputting a figure of the character configured by dividing a portion of the body thereof which can be moved into a plurality of regions on the basis of a corresponding joint of the character according to the parameterized vector value.

According to another aspect of the present invention, there is also provided a method for producing a moving picture, comprising the steps of:

configuring a corresponding face shape of a character according to phoneme information;

converting text information inputted from a user into speech information;

extracting phoneme information from the converted speech information; and

generating a facial expression and the shape of lips of the character corresponding to the extracted phoneme information from a plurality of face shapes of the character.

According to another aspect of the present invention, there is also provided a method for producing a moving picture, comprising the steps of:

configuring a corresponding face shape of a character according to phoneme information;

extracting phoneme information from speech information inputted from a user; and

generating a facial expression and the shape of lips of the character corresponding to the extracted phoneme information from a plurality of face shapes of the character.

According to another aspect of the present invention, there is also provided a method for producing a moving picture, comprising the steps of:

configuring a corresponding face shape and motion of a character according to phoneme information and motion information;

converting text information inputted from a user into speech information;

extracting phoneme information from the converted speech information;

generating a facial expression and the shape of lips of the character corresponding to the extracted phoneme information from a plurality of face shapes of the character; and

generating a movement of the character corresponding to motion information inputted from the user from a plurality of motions of the character.

It is preferred that the moving picture producing method may further include the steps of: generating a corresponding motion of the character according to the inputted motion information; generating a corresponding facial expression of the character according to inputted facial expression information; generating a corresponding background scene according to inputted background scene information; and generating a corresponding effective sound according to inputted sound information.

According to another aspect of the present invention, there is also provided a method for producing a moving picture, comprising the steps of:

configuring a corresponding face shape and motion of a character according to phoneme information and motion information;

extracting phoneme information from speech information inputted from a user;

generating a facial expression and the shape of lips of the character corresponding to the extracted phoneme information from a plurality of face shapes of the character; and

generating a movement of the character corresponding to motion information inputted from the user from a plurality of motions of the character.

### BRIEF DESCRIPTION THE DRAWINGS

The foregoing and other objects, features and advantages of the present invention will become more apparent from the following detailed description when taken in conjunction with the accompanying drawings in which:

FIG. 1 is a block diagram illustrating the construction of a computer system employed in a moving picture producing system according to a preferred embodiment of the present invention;

FIG. 2 is a block diagram illustrating the construction of a moving picture producing system according to a preferred embodiment of the present invention;

FIG. 3 is a table illustrating phoneme information extracted from speech information;

FIG. 4 is a table illustrating a vector set into which the shape of lips of a character is classified in a moving picture producing system according to a preferred embodiment of the present invention;

FIG. 5 is a flowchart illustrating the process for creating a facial expression of a character in a moving picture producing method according to a preferred embodiment of the present invention;

FIG. 6 is a view illustrating a series of processes for creating a specific facial expression of a character on a screen in a moving picture producing method according to a preferred embodiment of the present invention;

FIG. 7 is a flowchart illustrating the process for creating a facial expression of a character through a speech information-converting engine and a lip synchronizing-creating engine in a moving picture producing method according to a preferred embodiment of the present invention;

FIG. 8 is a view illustrating the shape of a simple joint for controlling a movement of a character in a moving picture producing system according to a preferred embodiment of the present invention;

FIG. 9 is a view illustrating the shape of a joint of a human body when performing a joint handling of a human type model in a moving picture producing system according to a preferred embodiment of the present invention;

FIG. 10 is a block diagram illustrating the construction of a moving picture producing system according to another preferred embodiment of the present invention, in which phoneme information is extracted directly from speech information without using a speech information-converting engine to generate a facial expression and the shape of lips of a character;

FIG. 11 is a flowchart illustrating the process for producing a three-dimensional (3D) character in a moving picture producing method according to a preferred embodiment of the present invention;

FIG. 12 is a flowchart illustrating the process for extracting phoneme information using a speech information-converting engine and generating a lip synchronizing of a character according to the extracted phoneme information in a moving picture producing method according to a preferred embodiment of the present invention; and

FIG. 13 is a flowchart illustrating the process for generating a lip synchronizing of a three-dimensional (3D) character using a speech recognition technology in a moving picture producing method according to a preferred embodiment of the present invention.

### DESRIPTION OF THE FREFERRED EMBODIMENTS

Reference will now be made in detail to the preferred embodiments of the present invention.

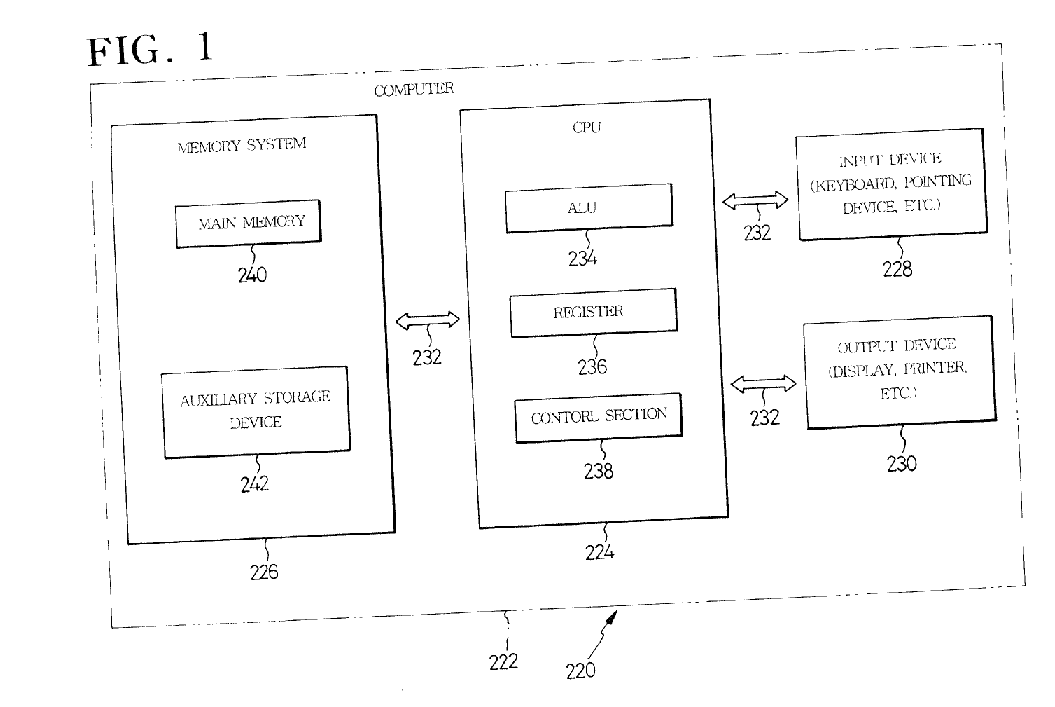

FIG. 1 is a block diagram illustrating the construction of a computer system employed in a moving picture producing system according to a preferred embodiment of the present invention.

Referring to FIG. 1, a computer system 220 having a computer 222 includes a memory system 226, at least one central processing unit (CPU) 224 connected to the memory system 226 for performing a high-speed operation, an input device 228, and an output device 230.

The CPU 224 includes an arithmetic logic unit (ALU) 234 for performing a calculation function, a register 236 for temporarily storing data and instruction, and a control section 238 for controlling the overall operation of the computer system 220. Also, the CPU 224 may be the Alpha CPU manufactured by Digital Co., MIPS manufactured by MIPS Technologies, Inc., NEC, IDT, Siemens, etc., x86 series manufactured by Intel, Cyrix, AMD and Nexgen, and a processor having various architectures such as Power PC manufactured by IBM and Motorola.

The memory system 226 generally includes a main memory 240 in the form of a high-speed storage medium such as an Random Access Memory (RAM) and an Read Only Memory (ROM), an auxiliary storage unit 242 in the form of a long-term storage medium such as a floppy disk, a hard disk, a tape, a CD-ROM, a flash memory, etc. Also, the main memory 240 may include a video display memory for displaying images through a display device. It will be apparent to those skilled in the art that the memory system 226 may include several types of products having various storage performances.

Further, the input device 228 and the output device 230 may be typically used input/output devices. The input device 228 may include a keyboard, a mouse, a physical transducer, etc., such as, for example, a touch screen or a microphone. The output device 230 may include a display device, a printer, a transducer such as a speaker, etc. Also, equipment such as a network interface or a modem may be used as the input device and/or output device.

The computer system 220 may include an operating system (OS) and at least one application program. The operating system is a set of software for controlling the operation of the computer system and resource allocation. The application program is a set of software for performing a task requested by a user by using a computer resource available through the operating system. The operating system and the application program will be resident in the memory system 226.

The present invention will be set forth according to the operation performed by the computer system 220 and a representation symbol with respect to the operation unless the present invention is set forth otherwise than as set forth above according to an experience of those skilled in the art of a computer programming. This operation is based on a computer and will be performed by an operating program or a suitable application program. Also, the operation represented by the symbol includes the process of the CPU 224 with respect to an electrical signal of data bit, etc., causing conversion or interruption of an electrical signal, and the management of data bit signal stored in a memory area within the memory system 226 to vary the operation of the computer system and processing a signal. The memory area where the data bit signal is managed is a physical region having electric, magnetic or optical characteristics corresponding to the data bit.

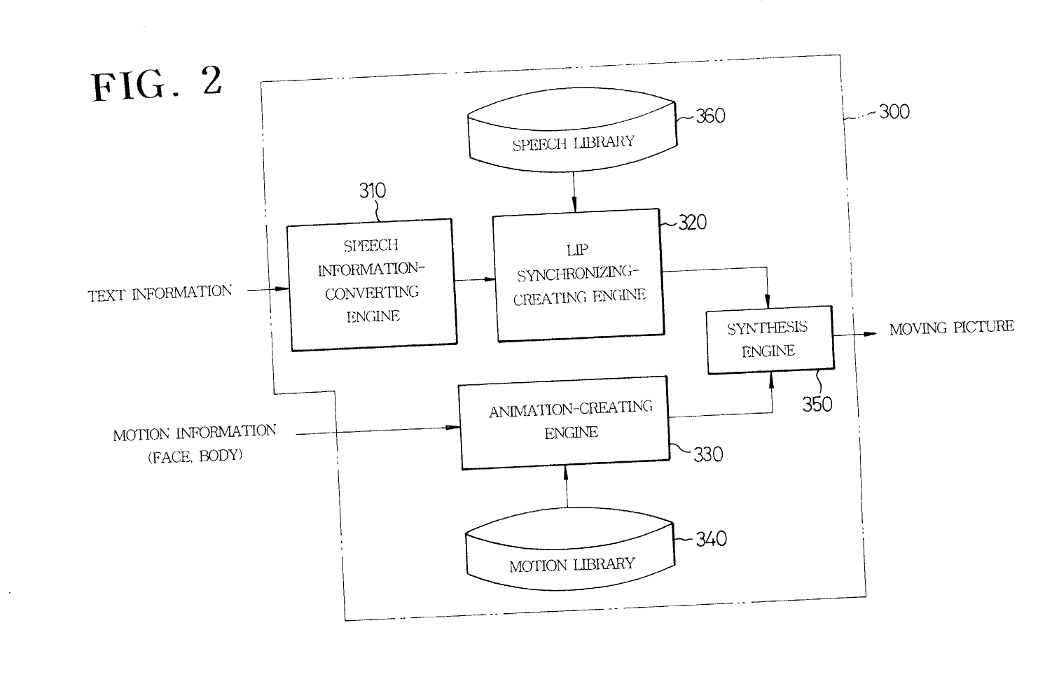

FIG. 2 is a block diagram illustrating the construction of a moving picture producing system according to a preferred embodiment of the present invention.

Referring to FIG. 2, a moving picture producing system 300 according to the present invention includes a speech information-converting engine 310 having a TTS (Text to Speech) engine for converting text information inputted by a user into speech information. The speech information outputted from the speech information-converting engine 310 is supplied to a lip synchronizing-creating engine 320. The lip synchronizing-creating engine 320 extracts each phoneme of an initial sound, a medial vowel and a final consonant from the speech information inputted thereto from the speech information-converting engine 310, and varies the shape of lips of a character to be displayed on a screen using the extracted phoneme. Also, the speech information-converting engine 310 has a configuration for converting text information as well as previously recorded speech information into a corresponding speech information.

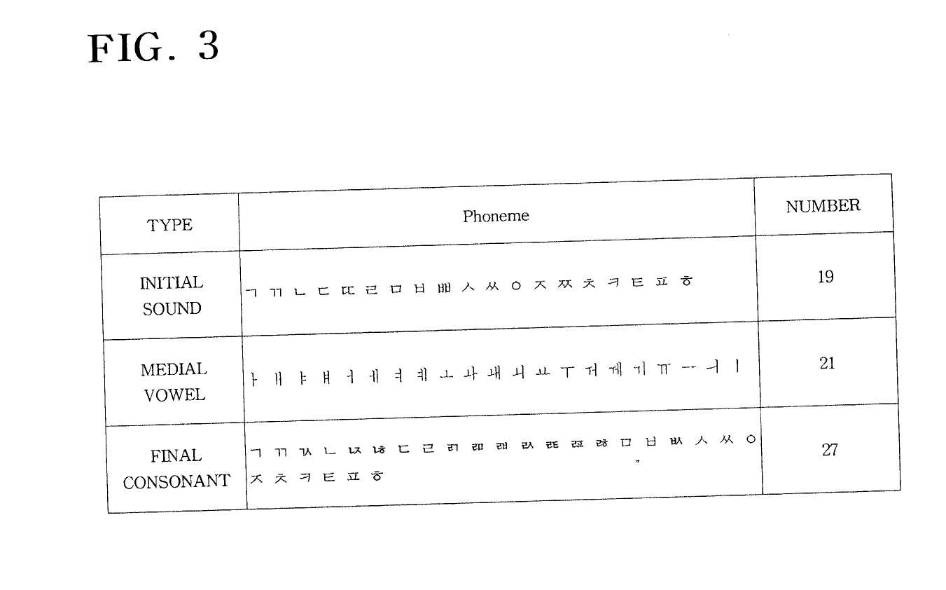

FIG. 3 is a table illustrating each phoneme extracted from speech information.

Referring to FIG. 3, in case of the Korean language, a phoneme can be classified into 19 initial sounds, 21 medial vowels, and 27 final consonants. On the other hand, in case of the English language, a phoneme can be classified into 5 vowels, 21 consonants, and other phonetic symbols.

The speech information generated from the speech information-converting engine 310 consists of a combination of such phonemes, and the shape of lips of the character can be varied by the combination of the phonemes.

For example, in the case where an initial sound of “ [symbol] ” and a medial vowel of “ [symbol] ” are included in speech information outputted from the speech information-converting engine 310, it is judged that a pronunciation is “ [symbol] ” so that the shape of lips of the character can be varied to open a mouth of the character.

The possible shape of lips of the character can be classified into some kinds of shapes of lips.

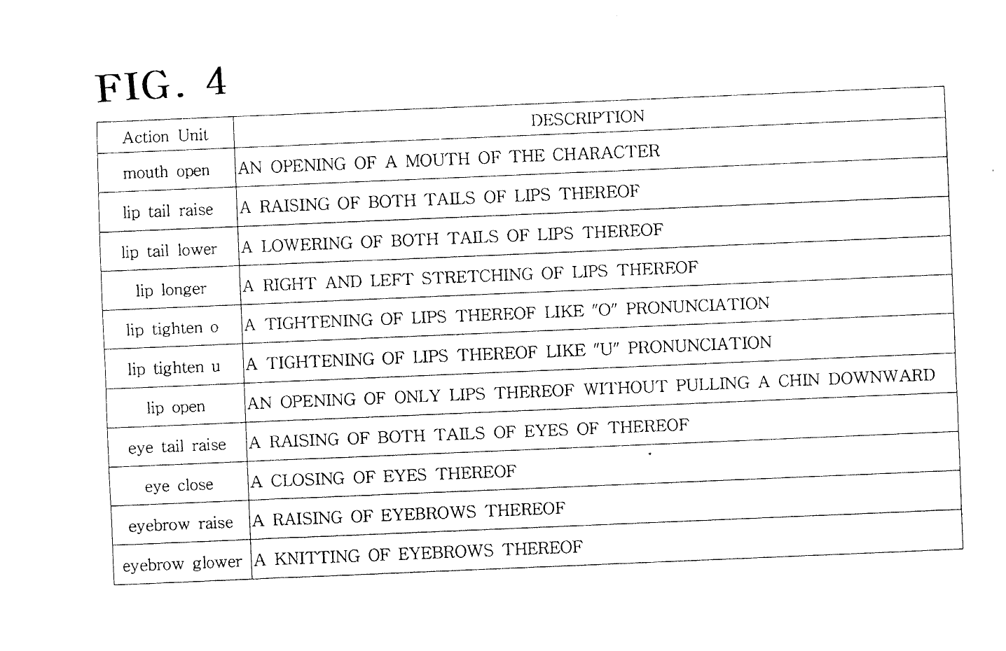

FIG. 4 is a table illustrating a vector set into which the shape of lips of a character is classified in a moving picture producing system according to a preferred embodiment of the present invention.

Referring to FIG. 4, a vector set with respect to the shape of lips of the character may include an opening of a mouth of the character, a rising of both tails of lips thereof, a lowering of both tails of lips thereof, a right and left stretching of lips thereof, a tightening of lips thereof like “o” pronunciation, a tightening of lips thereof like “u” pronunciation, an opening of only lips thereof without pulling a chin downward, a raising of both tails of eyes of thereof, a closing of eyes thereof, a raising of eyebrows thereof, and a knitting of eyebrows thereof. At this time, the vector set shown in FIG. 4 is not limited to the shape of lips of the character, but includes the contents about facial expressions of the character. Also, it will be apparent to those skilled in the art that the shape of lips and a facial expression that the character can express is not limited to the case of FIG. 4, but other shapes of lips and facial expressions can be added to the case of FIG. 4.

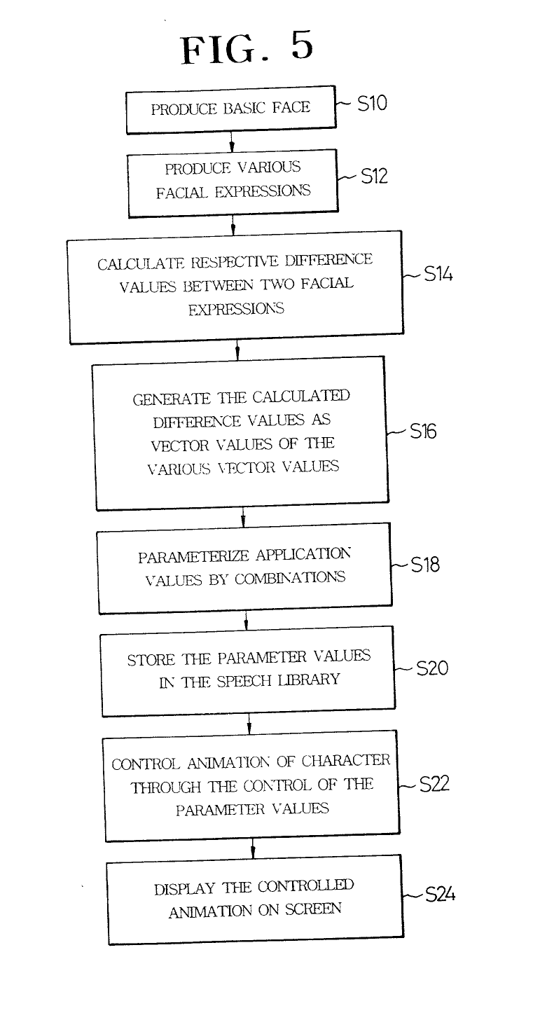

FIG. 5 is a flowchart illustrating the process for creating a facial expression of a character through a combination of phoneme information as described above.

Referring to FIG. 5, first, a basic face of a character is produced (S10). Then, various facial expressions of the character are produced based on the basic face thereof (S12). Difference values between the basic face of the character and each of the various facial expressions thereof are calculated on the basis of the basic face thereof (S14). The calculated difference values with respect to the basic face are generated as vector values and application values by a combination of the generated vector values are generated as parameter values (S18). The generated parameter values are stored in a speech library (S20). Finally, when text information is inputted to the speech information-converting engine from a user, the control of the parameter values controls an animation of the character according to the inputted text information (S22) to display the controlled animation of the character on a screen (S24).

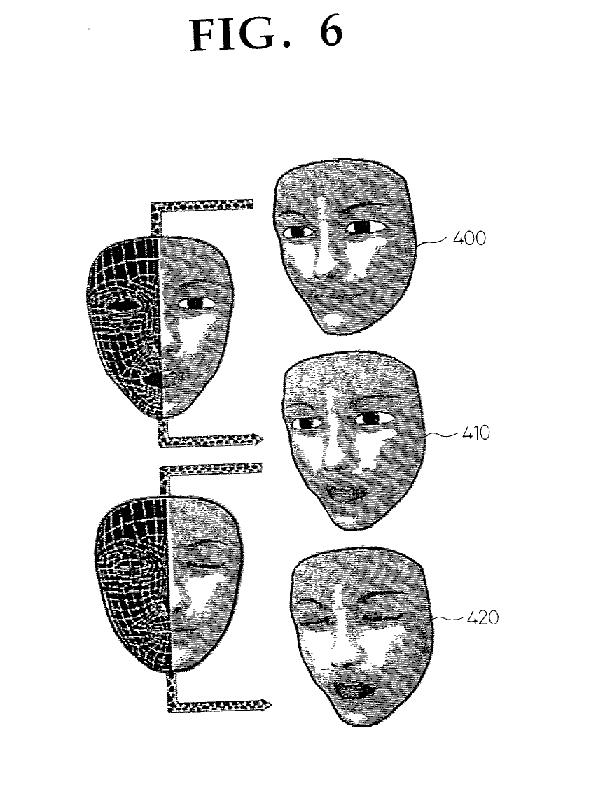

FIG. 6 is a view illustrating a series of processes for creating a specific facial expression of a character on a screen like in FIG. 5 in a moving picture producing method according to a preferred embodiment of the present invention;

Referring to FIG. 6, when there is produced an expressionless basic face 400 of the character whose eyes are opened with his/her lips kept tight, a vector set by a character model having a facial expression with closed eyes and a vector set by a character model having a facial expression with an opened mouth are applied to the basic face 400 simultaneously to create a new facial expression of the character whose eyes are closed with his/her mouth opened. That is, after a facial expression 410 with an opened mouth is first created, a facial expression with closed eyes is added to the facial expression 410 with the opened mouth. As a result, a facial expression 420 of the character whose mouth is opened with his/her eyes closed can be created.

In such a manner, several facial expression models are synthesized to create new facial expressions. When each facial expression is synthesized, the degree at which each vector set is applied is parameterized. Preferably, the value of the applicable degree is a real number between 0 and 1. But, the applicable degree value may be a value outside the range of the real number for an exaggerative expression, etc. For example, in the case where a vector value of an original facial expression with an opened mouth is set to 1, when a vector value of a facial expression with an opened mouth is 0.5, the size of the opened mouth of the facial expression having a vector value of 0.5 is about half as large as that of the opened mouth of the original facial expression. In the meantime, when a vector value of a facial expression with an opened mouth is 1.5, the size of the opened mouth of the facial expression having a vector value of 1.5 will be about one and a half as large as that of the opened mouth of the original facial expression.

Like this, a data base must be configured in such a fashion that the shape of lips or a facial expression of the character corresponds to the shape of a face of the character according to phoneme information extracted from speech information. Such data is stored in the speech library 360 which, in turn, provides the data to the lip synchronizing-creating engine 320.

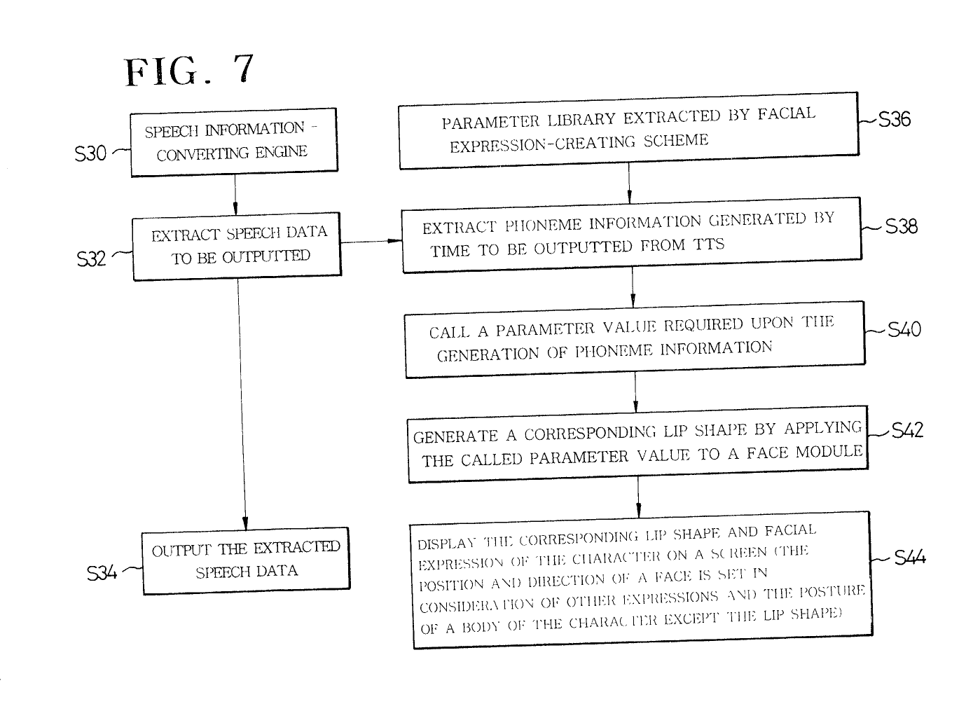

FIG. 7 is a flowchart illustrating the process for creating a facial expression of a character through a speech information-converting engine 310 and a lip synchronizing-creating engine 320 in a moving picture producing method according to a preferred embodiment of the present invention.

Referring to FIG. 7, first, when a user inputs text information, the speech information-converting engine 310 extracts speech data to be outputted by converting the inputted text information into speech information (S30, S32). The extracted speech data is outputted to the lip synchronizing-creating engine 320 through an output device such as a speaker (S34), and the lip synchronizing-creating engine 320 extracts phoneme information from the speech data inputted thereto from the speech information-converting engine 310 (S38). At this time, the lip synchronizing-creating engine 320 calls a parameter value of a facial expression required upon the generation of phoneme information with respect to each of the facial expressions from a parameter library extracted by a facial expression-creating scheme (S36, S49). Then, the lip synchronizing-creating engine 320 generates a corresponding shape of lips of the character by applying the extracted phoneme information according to the called parameter value to a face module (S42). The generated corresponding shape of lips and a facial expression of the character are displayed on a screen (S44). At this time, the position and direction of a face of the character can be established in consideration of other facial expressions and the posture of a body of the character except the shape of lips thereof.

Meanwhile, the movement of a head, arms and legs of a character besides the shape of lips and a facial expression thereof will be created from the animation-creating engine 330 (see FIG. 2) which has received motion information from a user. The animation-creating engine 330 may employ a motion library 340 including a corresponding figure of the character according to motion information in a similar manner to the case of the lip synchronizing-creating engine 320.

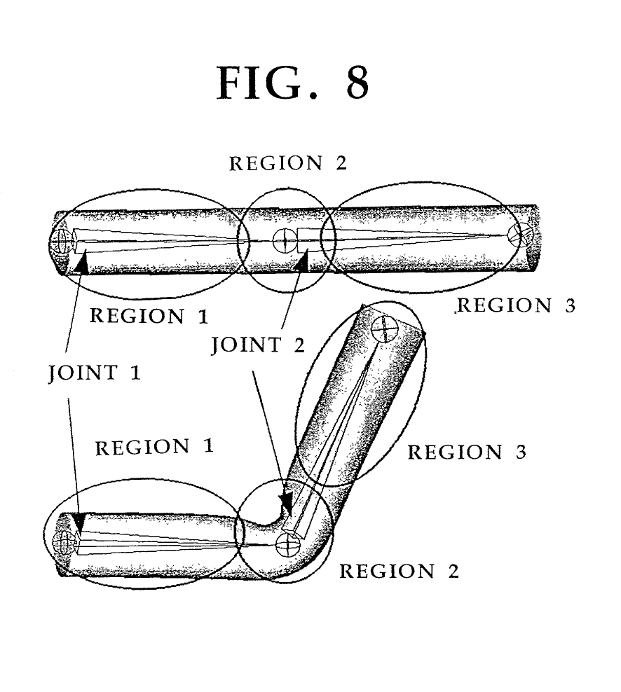

FIG. 8 is a view illustrating the shape of a simple joint for controlling a movement of a character in a moving picture producing system according to a preferred embodiment of the present invention.

Referring to FIG. 8, the movement of a joint varies with the position of a central joint and a variation of an angle of each joint. The surface of an object (a joint of a human body, etc.) to which a movement is applied may be composed of a small polygon. Also, the object can be moved by updating the position of vertexes of the polygon. In order to process the movement of a joint, first, a virtual joint (not shown) is positioned. It is determined that how much each of the vertexes will be affected by a movement of each joint for an update of the position thereof. At this time, it is preferred that the degree by which each of the vertexes is affected by a movement of each joint is determined as a value between 0 and 1. The degree by which vertexes included in a region 1 of FIG. 8 is affected by a joint 1 will become 1 or so, and the degree by which vertexes included in a region 2 is affected by each of the joints 1 and 2 will become 0.5 or so. Also, when the degree by which vertexes included in a region 3 is affected by the joint 2 becomes 1 or so, the joint 2 can be moved to perform a joint handling as shown in FIG. 8. In order to smoothly process the movement of a body like arms or legs of the character, the regions 1, 2 and 3 must not be sorted clearly, but must be configured in such a fashion that they are connected with each other. Further, it may be preferred that the number of the polygons of a joint of the character is around 3000 in consideration of the processing speed of a moving picture and the amount of data. A typical three-dimensional (3D) authoring tool supporting a polygon scheme to produce a three-dimensional (3D) character includes Maya or 3D Max, etc.

The possible motion of the character can be produced from a motion control data in such a fashion that a motion thereof is captured by using motion capture equipment to build a data base, and is adjusted to conform to the character using the built data base.

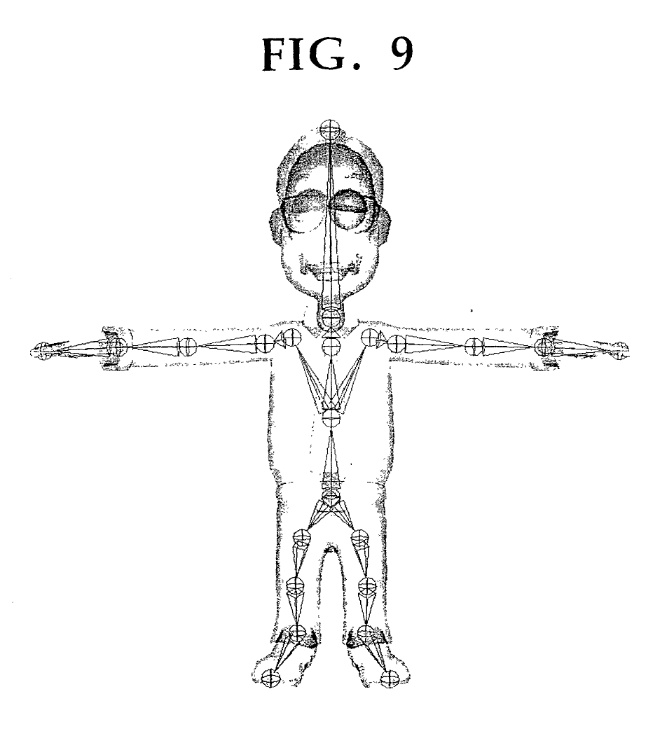

FIG. 9 is a view illustrating the shape of a joint of a human body when performing a joint handling of a human type model in such a method in a moving picture producing system according to a preferred embodiment of the present invention.

Referring to FIG. 9, finally, the facial expression and the shape of lips of the character generated from the lip synchronizing-creating engine 320 and the movement of the character generated from the animation-creating engine 330 are synthesized by the synthesis engine 350, so that a complete figure of the character is outputted as a moving picture on a screen.

Accordingly, when a user inputs text information, a speech according to the inputted text information and a facial expression of the character corresponding to the speech or a movement of a body thereof will be outputted.

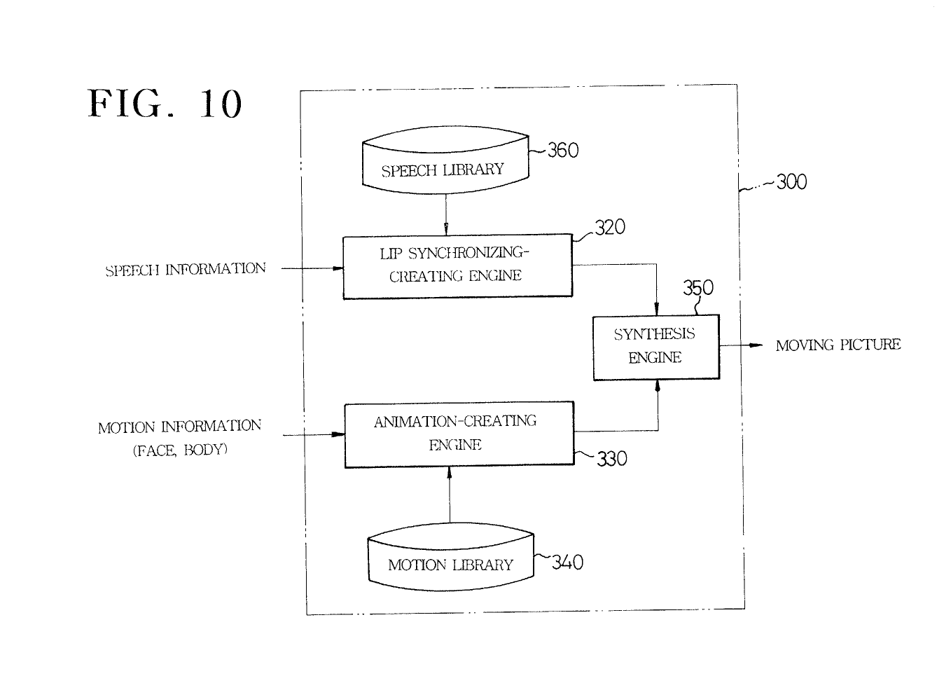

FIG. 10 is a block diagram illustrating the construction of a moving picture producing system according to another preferred embodiment of the present invention, in which phoneme information is extracted directly from speech information without using a speech information-converting engine to generate a facial expression and the shape of lips of a character.

Referring to FIG. 10, in this case, since phoneme information is extracted directly from speech information outputted from a mouth of a user without converting text information into speech information, the speech information-converting engine is not required. However, in case of utilizing previously recorded speech information, the moving picture producing system has a configuration which converts the previously recorded speech information into corresponding speech information by using the speech information-converting engine.

Also, the lip synchronizing-creating engine 320 for generating a facial expression and the shape of lips of the character, the animation-creating engine 330 for generating the movement of a body of the character, and the synthesis engine 350 for synthesizing the output signals generated from the lip synchronizing-creating engine 320 and the animation-creating engine 330 to generate a complete figure of the character are the same as those of FIG. 2.

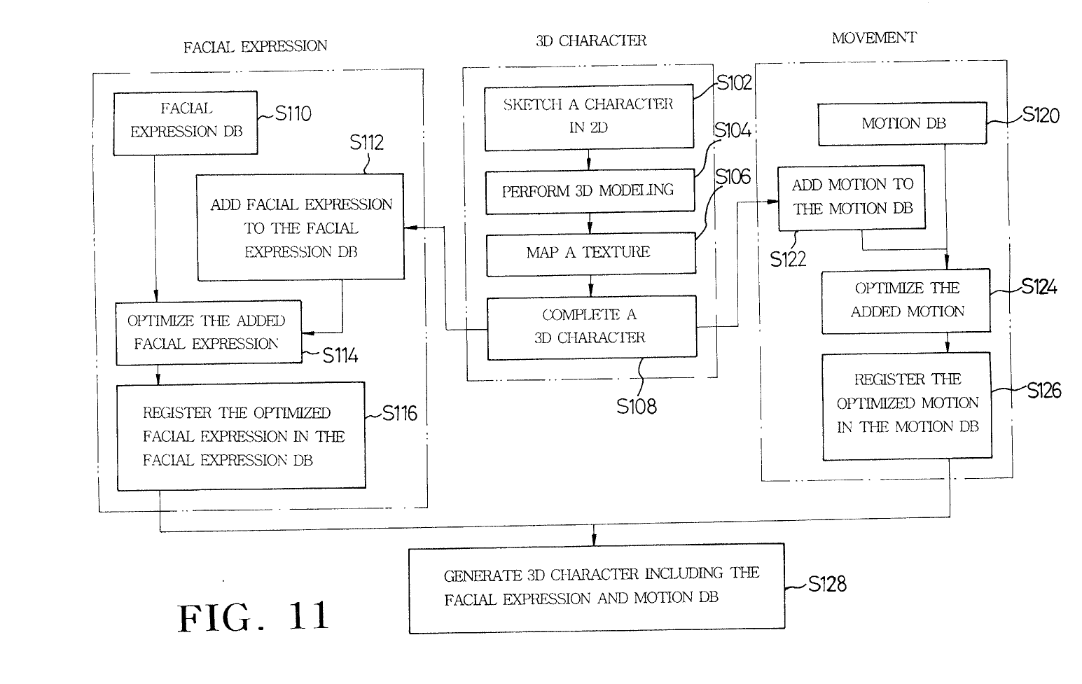

FIG. 11 is a flowchart illustrating the process for producing a three-dimensional (3D) character in a moving picture producing method according to a preferred embodiment of the present invention.

Referring to FIG. 11, first, a character is sketched in a two dimension (2D) to create a three-dimensional (3D) character (S102). A three-dimensional (3D) modeling is performed using the two-dimensional (2D) sketch (S104) and a texture with respect to each portion of the modeled three-dimensional (3D) character is mapped (S106) so that a three-dimensional (3D) character is completed (S108). The texture mapping process is a process in which a texture with a color and a sense of depth is combined with a surface between a line and another line of the modeled data.

In the meantime, a facial expression of the three-dimensional (3D) character is added to a facial expression data base (DB) (S110) by the completed three-dimensional (3D) character (S112), and the added facial expression of the three-dimensional (3D) character is optimized to form a facial expression suiting the three-dimensional (3D) character the most (S114). Then, the optimized facial expression of the character is registered in a facial expression data base (DB) (s116).

Similarly, a motion of the three-dimensional (3D) character is added to a motion data base (DB) (S120) by the completed three-dimensional (3D) character (S122). The added motion of the three-dimensional (3D) character undergoes a motion optimization process (Sl24), and the optimized motion of the character is registered in a motion data base (DB) (S126) in the same manner as the facial expression-registering process.

Accordingly, the three-dimensional (3D) character including the facial expression data base (DB) and the motion data base (DB) is generated (S128).

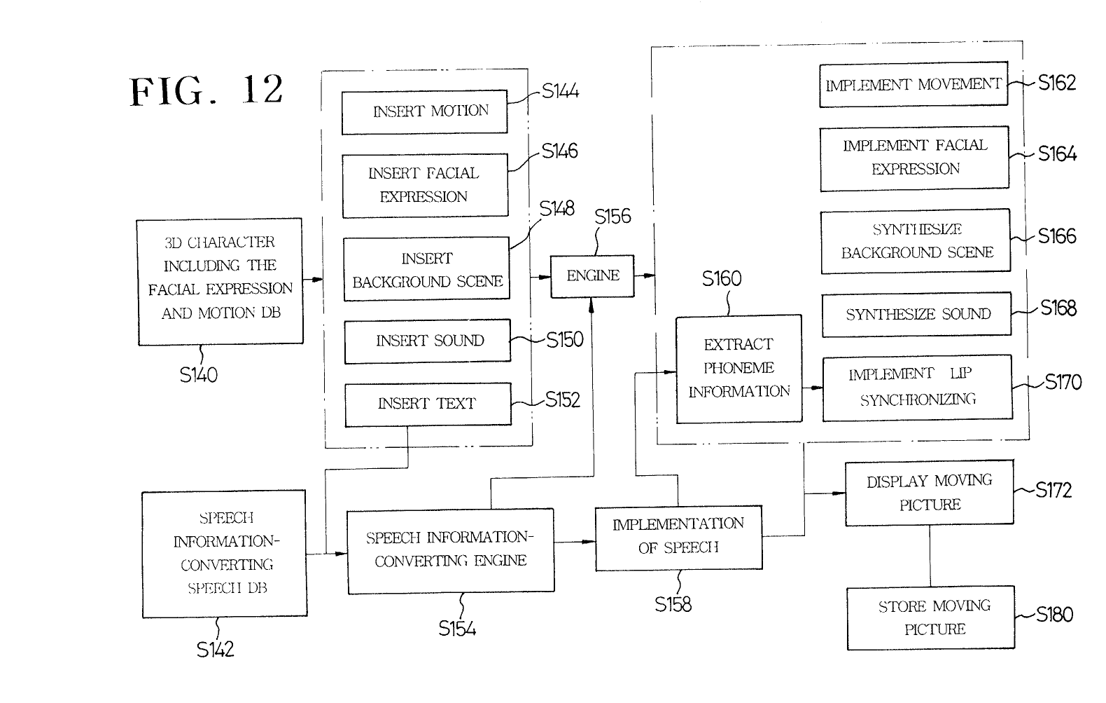

FIG. 12 is a flowchart illustrating the process for extracting phoneme information using a speech information-converting engine and generating a lip synchronizing of a character according to the extracted phoneme information in a moving picture producing method according to a preferred embodiment of the present invention.

Referring to FIG. 12, a motion, a facial expression, a background scene, a sound and a text is inserted with respect to the three-dimensional (3D) character (S140) including the facial expression data base (DB) and the motion data base (DB) (S144, . . . ,S152). At this time, information on the inserted motion, facial expression, background scene, sound and text is inputted to an engine (S156) which implements a movement and a facial expression of the three-dimensional (3D) character (S162, S164) and synthesizes the background scene and the sound, respectively, (S166, S168).

On the other hand, the inserted text is supplied to a speech information-converting engine (S154) which converts it into speech information using a speech data base (DB) (S142, S158). Phoneme information is extracted from the converted speech information through the lip synchronizing-creating engine (S160), and a lip synchronizing of the three-dimensional (3D) character is implemented according to the extracted phoneme information (S170).

Finally, a movement and a facial expression of the three-dimensional (3D) character are implemented, and the background scene and the sound are synthesized according to the contents of the inserted motion, facial expression, background scene, sound and text. Also, the shape of lips of the three-dimensional (3D) character is varied to correspond to the text information inputted by a user so that a moving picture is displayed on a screen (S172). The displayed moving picture may be stored in a data base (S180).

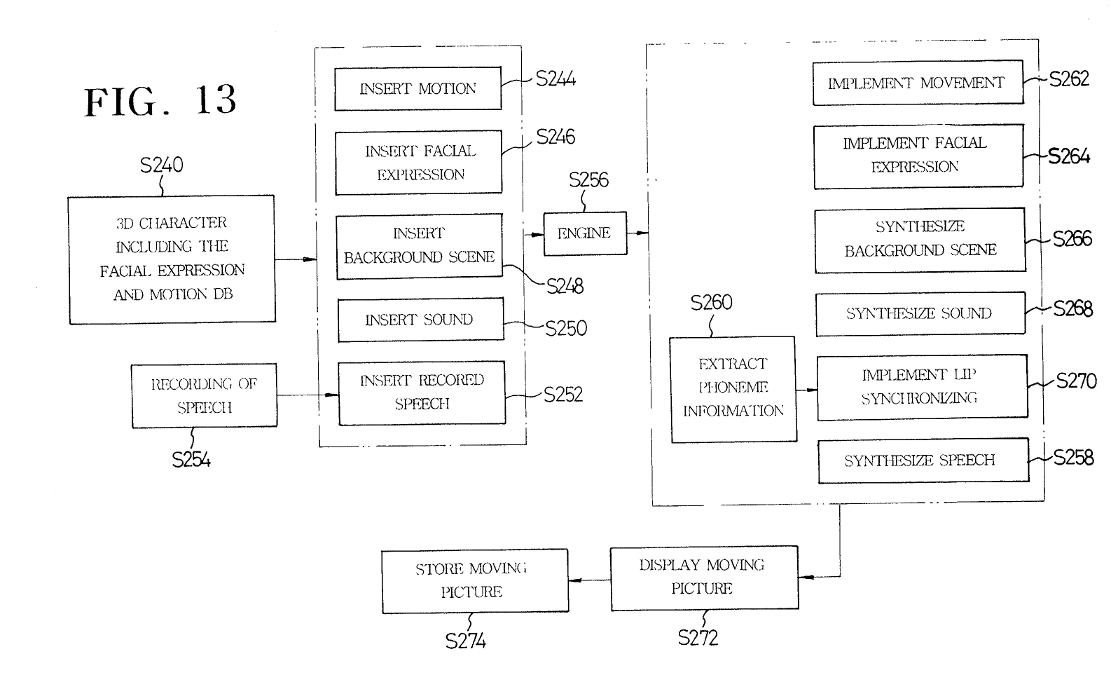

FIG. 13 is a flowchart illustrating the process for generating a lip synchronizing of a three-dimensional (3D) character using a speech recognition technology in a moving picture producing method according to a preferred embodiment of the present invention.

Referring to FIG. 13, since the process (S244, . . . ,S250) for inserting a motion, a facial expression, a background scene and a sound of the three-dimensional (3D) character is identical to that of FIG. 12, but does not employ the speech information-converting engine, a speech recorded by a user is inputted (S254, S252).

Information on the inserted motion, facial expression, background scene, sound and text is inputted to an engine (S256) which implements a movement and a facial expression of the three-dimensional (3D) character (S262, S264) and synthesizes the background scene and the sound (S266, S268).

On the other hand, Phoneme information is extracted from the inserted speech information through the lip synchronizing-creating engine (S260), and a lip synchronizing of the three-dimensional (3D) character is implemented according to the extracted phoneme information (S270). Also, the speech is synthesized (S258).

Like this, a movement and a facial expression of the three-dimensional (3D) character are created, a moving picture is displayed on a screen (S272). At this time, the displayed moving picture may be stored in a data base (S274).

As can be seen from the foregoing, according to the moving picture producing system and method of the present invention, since a three-dimensional (3D) moving picture can be produced more easily than a conventional three-dimensional (3D) character-producing scheme, general people except moving picture experts can also use the three-dimensional (3D) moving picture.

Further, the moving picture producing system of the present invention has several advantages in that the producing speed and the processing speed of the three-dimensional (3D) moving picture are high, the cost of production is low.

Moreover, since the three-dimensional (3D) moving picture produced by the present invention allows motion data and facial animation data of a character to be reused, the producing process of the three-dimensional (3D) moving picture hereafter can be performed economically and easily.

The three-dimensional (3D) moving picture produced by the system and method of the present invention can be utilized for VOD (video on demand) service, a real-time streaming, etc., on the Internet. In addition, the present invention has almost infinite applicable fields including educational contents, an introduction of products and articles, a publicity of companies, etc.

While a moving picture producing system and method of this invention has been described in connection with what is presently considered to be the most practical and preferred embodiment, it is to be understood that the invention is not limited to the disclosed embodiment, but, on the contrary, it is intended to cover various modifications within the spirit and scope of the appended claims.

What is claimed is:

1. A system for producing a moving picture, comprising:
a memory system adapted to store information on a facial expression, the shape of lips, and a motion of a character;
a speech information-converting engine adapted to receive text information and/or previously recorded speech information from a user and to convert the inputted text information and/or previously recorded speech information into a corresponding speech information;
a lip synchronizing-creating engine adapted to extract phoneme information from speech information outputted from the speech information-converting engine, and to generate a facial expression and the shape of lips of the character corresponding to the extracted phoneme information from the memory system;
an animation-creating engine adapted to receive motion information from the user and to generate a movement of the character corresponding to the motion information from the memory system; and
a synthesis engine adapted to synthesize the facial expression and the lips shape of the character generated from the lip synchronizing-creating engine and the movement of the character generated from the animation-creating engine to display the synthesized ones on a screen.

2. The system according to claim 1, wherein the facial expression of the character comprises at least one of an opening of a mouth of the character, a rising of both tails of lips thereof, a lowering of both tails of lips thereof, a right and left stretching of lips thereof, a tightening of lips thereof like “o” pronunciation, a tightening of lips thereof like “u” pronunciation, an opening of only lips thereof without pulling a chin downward, a raising of both tails of eyes of thereof, a closing of eyes thereof, a raising of eyebrows thereof, and a knitting of eyebrows thereof.

3. The system according to claim 1 further comprising: modeling means adapted to model a sketch character and texture mapping means adapted to map a texture to the modeled sketch character; a motion engine adapted to implement the movement of the character according to inputted motion information; a facial expression engine adapted to implement the facial expression of the character according to inputted facial expression information; a background scene engine adapted to implement a background scene according to inputted background scene information; and a sound engine adapted to synthesize a sound according to inputted sound information.

4. The system according to claim 1, wherein the memory system comprises:
a motion library adapted to store motion information of the character;
a facial expression library adapted to store facial expression information of the character;
a background scene library adapted to store information on a background scene of the character; and
a sound library adapted to store sound information.

5. A system for producing a moving picture, comprising:
a memory system adapted to store information on a facial expression, the shape of lips, and a motion of a character;
a lip synchronizing-creating engine adapted to extract phoneme information from speech information inputted by a user, and to generate a facial expression and the shape of lips of the character corresponding to the extracted phoneme information from the memory system;
an animation-creating engine adapted to receive motion information from the user and to generate a movement of the character corresponding to the motion information from the memory system; and
a synthesis engine adapted to synthesize the facial expression and the lip shape of the character generated from the lip synchronizing-creating engine and the movement of the character generated from the animation-creating engine to display the synthesized ones on a screen.

6. A method for producing a moving picture, comprising the steps of:
producing a basic face of a character;
producing various facial expressions of the character with respect to the basic face thereof;
calculating a difference value between the basic face of the character and each of the various facial expressions thereof;
generating a vector value from the calculated difference value and parameterizing the generated vector value; and outputting a corresponding face shape of the character according to the parameterized vector value.

7. A method for producing a moving picture, comprising the steps of:
producing a basic figure for a face and a body of a character;
producing various figures of the character which can be created by a variation of the shape of the face or the body of the character with respect to the basic figure thereof;
calculating a difference value between the basic figure of the character and each of the various figures thereof;
generating a vector value from the calculated difference value and parameterizing the generated vector value; and
outputting a corresponding figure of the character configured by dividing a portion of the body thereof which can be moved into a plurality of regions on the basis of a joint of the character according to the parameterized vector value.

8. A method for producing a moving picture, comprising the steps of:
configuring a corresponding face shape of a character according to phoneme information;
converting text information inputted from a user into speech information;
extracting phoneme information from the converted speech information; and
generating a facial expression and the shape of lips of the character corresponding to the extracted phoneme information from a plurality of face shapes of the character.

9. The method according to claim 8, wherein the configuring step further comprises the steps:
producing a basic face of a character;
producing various facial expressions of the character with respect to the basic face thereof;
calculating a difference value between the basic face of the character and each of the various facial expressions thereof;
generating a vector value from the calculated difference value and parameterizing the generated vector value; and
outputting a corresponding face shape of the character according to the parameterized vector value.

10. A method for producing a moving picture, comprising the steps of:
configuring a corresponding face shape of a character according to phoneme information;
extracting phoneme information from speech information inputted from a user; and
generating a facial expression and the shape of lips of the character corresponding to the extracted phoneme information from a plurality of face shapes of the character.

11. A method for producing a moving picture, comprising the steps of:
configuring a corresponding face shape and motion of a character according to phoneme information and motion information;
converting text information inputted from a user into speech information;
extracting phoneme information from the converted speech information;
generating a facial expression and the shape of lips of the character corresponding to the extracted phoneme information from a plurality of face shapes of the character; and
generating a movement of the character corresponding to motion information inputted from the user from a plurality of motions of the character.

12. The method according to claim 11 further comprising the steps of:
generating a corresponding motion of the character according to the inputted motion information;
generating a corresponding facial expression of the character according to inputted facial expression information;
generating a corresponding background scene according to inputted background scene information; and
generating a corresponding effective sound according to inputted sound information.

13. A method for producing a moving picture, comprising the steps of:
configuring a corresponding face shape and motion of a character according to phoneme information and motion information;
extracting phoneme information from speech information inputted from a user;
generating a facial expression and the shape of lips of the character corresponding to the extracted phoneme information from a plurality of face shapes of the character; and
generating a movement of the character corresponding to motion information inputted from the user from a plurality of motions of the character.

14. A recording medium in which program of instructions executable by a digital processing device is implemented to have a form to perform a real-time moving picture producing method using speech information, and which can be read by the digital processing device, the moving picture producing method, comprising the steps of:
producing a basic face of a character;
producing various facial expressions of the character with respect to the basic face thereof;
calculating a difference value between the basic face of the character and each of the various facial expressions thereof;
generating a vector value from the calculated difference value and parameterizing the generated vector value; and
outputting a corresponding face shape of the character according to the parameterized vector value.

15. A recording medium in which program of instructions executable by a digital processing device is implemented to have a form to perform a real-time moving picture producing method using speech information, and which can be read by the digital processing device, the moving picture producing method, comprising the steps of:
producing a basic figure of a character;
producing various figures of the character with respect to the basic figure thereof;
calculating a difference value between the basic figure of the character and each of the various figures thereof;
generating a vector value from the calculated difference value and parameterizing the generated vector value; and
outputting a corresponding figure of the character according to the parameterized vector value.

16. A recording medium in which program of instructions executable by a digital processing device is implemented to have a form to perform a real-time moving picture producing method using speech information, and which can be read by the digital processing device, the moving picture producing method, comprising the steps of:
configuring a corresponding face shape of a character according to phoneme information;
converting text information inputted from a user into speech information;
extracting phoneme information from the converted speech information; and
generating a facial expression and the shape of lips of the character corresponding to the extracted phoneme information from a plurality of face shapes of the character.

17. A recording medium in which program of instructions executable by a digital processing device is implemented to have a form to perform a real-time moving picture producing method using speech information, and which can be read by the digital processing device, the moving picture producing method, comprising the steps of:
configuring a corresponding face shape and motion of a character according to phoneme information and motion information;
converting text information inputted from a user into speech information;
extracting phoneme information from the converted speech information;
generating a facial expression and the shape of lips of the character corresponding to the extracted phoneme information from a plurality of face shapes of the character; and
generating a movement of the character corresponding to motion information inputted from the user from a plurality of motions of the character.

18. A recording medium in which program of instructions executable by a digital processing device is implemented to have a form to perform a real-time moving picture producing method using speech information, and which can be read by the digital processing device, the moving picture producing method, comprising the steps of:
configuring a corresponding face shape of a character according to phoneme information
extracting phoneme information from speech information inputted from a user; and
generating a facial expression and the shape of lips of the character corresponding to the extracted phoneme information from a plurality of face shapes of the character.

19. A recording medium in which program of instructions executable by a digital processing device is implemented to have a form to perform a real-time moving picture producing method using speech information, and which can be read by the digital processing device, the moving picture producing method, comprising the steps of:
configuring a corresponding face shape and motion of a character according to phoneme information and motion information;
extracting phoneme information from speech information inputted from a user;
generating a facial expression and the shape of lips of the character corresponding to the extracted phoneme information from a plurality of face shapes of the character; and
generating a movement of the character corresponding to motion information inputted from the user from a plurality of motions of the character.
